(19) United States
(12) Patent Application Publication
(10) Pub. No.: US 2008/0113103 A1
(43) Pub. Date: May 15, 2008

(54) HALOGEN TREATMENT OF POLYMER FILMS USING ATMOSPHERIC PLASMA

(75) Inventors: James A. Claar, Apollo, PA (US); Truman F. Wilt, Clinton, PA (US); Edward R. Millero, Gibsonia, PA (US); Kaliappa G. Ragunathan, Gibsonia, PA (US); David A. Diehl, Pittsburgh, PA (US)

Correspondence Address: Carol A. Marmo;PPG Industries, Inc., Law - Intellectual Property 39S, One PPG Place, Pittsburgh, PA, 15272, US

(73) Assignee: PPG INDUSTRIES OHIO, INC., Cleveland, OH (US)

(21) Appl. No.: 11/689,063

(22) Filed: Mar. 21, 2007

Related U.S. Application Data
(60) Provisional application No. 60/865,304, filed on Nov. 10, 2006.

(51) Int. Cl. B05D 3/04

(52) U.S. Cl. 427/444

(57) ABSTRACT

A method of treating a surface coating with a halogen-containing plasma generated at atmospheric pressure is disclosed.

### CROSS REFERENCE TO RELATED APPLICATION

This application claims priority to provisional application Ser. No. 60/865,304 filed Nov. 10, 2006.

### FIELD OF THE INVENTION

The present invention relates to atmospheric pressure generated plasma, surface treatment of polymer films, and more particularly relates to surface treatment using a halogen-containing plasma.

### BACKGROUND OF THE INVENTION

Protective and decorative surface coatings comprise a continuous film of a polymer. Typically, the polymer forms a matrix binding together pigments, fillers, plasticizers and other ingredients typically found in a paint film. The properties of the coating or paint film are determined in a large part on the identity of the polymer. Certain polymers such as halogen-containing polymers have outstanding exterior durability but are relatively expensive. Other polymers such as polyester and poly(ester-urethane) have excellent blends of properties for industrial applications such as flexibility, hardness, solvent resistance and humidity resistance, and are less expensive than fluoropolymer-based coatings but do not have the outstanding exterior durability associated with the fluoropolymer-based coatings.

Therefore, it would be desirable to treat a paint film such as those containing polyesters and poly(ester-urethanes) with a halogen to impart improved properties to the paint film such as those associated with a paint film based on a halogen-containing polymer. Further, it would be desirable to conduct the treatment on a continuous basis as are typically used in industrial coating applications.

### SUMMARY OF THE INVENTION

The present invention provides a process for treating a coating layer adhered to the substrate. The process comprises placing the coated substrate into a halogen-containing plasma discharged at atmospheric pressure.

### BRIEF DESCRIPTION OF THE DRAWINGS

FIG. 1 is a cross-sectional view showing an example of a plasma reaction apparatus used in the method of the present invention;

FIG. 2 is a cross-sectional view showing an example of an apparatus used in the present invention that carries out the atmospheric plasma treatment continuously.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

A suitable plasma source is a glow discharge plasma apparatus as described in U.S. Pat. No. 5,414,324. Basically, this apparatus comprises a chamber containing spaced-apart electrodes having opposing surfaces. A relatively inert gas such as helium or argon is fed into the chamber along with a source of halogen. The electrodes are energized typically by a radio frequency power amplifier to cause a glow discharge to take place to perform the plasma excitation that results in the surface treatment of the coated article.

A plasma is defined as an ionized gas containing not only ions but also typically free radicals, electrons and molecular fragments. It is believed the halogen contained in the plasma is in an excited state being in the form such as those mentioned above. In this form it is believed to be very reactive with the coating layer to form what is believed to be a submicron layer of a halogen containing polymer so as to modify the layer giving it characteristics of the halogen containing polymer. For example, a non-fluorinated coating layer such as a polyester or a poly(ester-urethane), when treated with a fluorine-containing plasma, will take on the properties similar to a fluoropolymer-based coating.

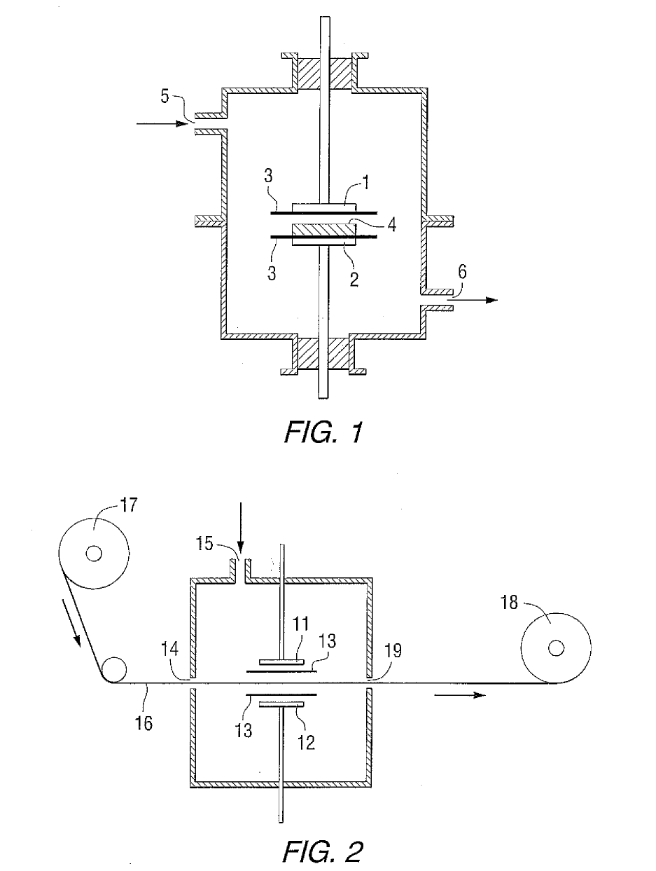

With reference to the drawings, FIG. 1 is a cross-sectional view schematically showing a plasma reaction apparatus for carrying out atmospheric pressure plasma surface treatment by holding in place a coated substrate to be treated between electrodes. An upper electrode 1 and a lower electrode 2 are provided opposing one to another. A dielectric coating or layer 3 is affixed on a lower side of the electrode 1 and on an upper side of the lower electrode 2 as well. The dielectric layer 3 is necessary for continuing glow discharge in a stable state. When the object to be treated is a relatively thick coated substrate, the dielectric layer may be affixed only to the upper layer 1.

On the upper side of the lower electrode 2 is placed a coated substrate 4 to be treated. An inert gaseous composition containing, for example, helium or neon or mixtures thereof and a halogen such as fluorine or chlorine is introduced through an inlet port 5, and discharged from an outlet port 6. While the flow rate of the gas is freely set up to a desired value, the gas introduction may be stopped when the residual air within the apparatus is completely replaced by the gas.

Next, a high frequency voltage is applied between the upper and lower electrodes to cause glow discharge to take place to perform plasma excitation in order to surface-treat the coating.

FIG. 2 illustrates an example of the atmospheric pressure surface treatment process of the present invention in which a coated substrate is continuously surface-treated. A pair of opposing electrodes, i.e., an upper electrode 11 and a lower electrode 12, have respective dielectric coatings or layers 13 on their lower and upper sides, respectively. Through a slit 14 provided in the wall of the plasma reaction apparatus is supplied a coated substrate, for example, an aluminum substrate with a polyester coating to be surface-treated and enters the apparatus. The coated substrate is continuously supplied from a coil 17. The coated substrate passes a space defined between the upper and lower electrodes, goes out of the apparatus through a slit 19 formed in the wall of the apparatus and is taken up on a takeup coil 18. An inert gas containing the halogen source is continuously supplied into the plasma reaction apparatus through a gas supply port 15 and flows out of the apparatus through the slits 14 and 17. The inside of the plasma reaction apparatus is kept at a suitable, slightly superatmospheric pressure so that the air outside the apparatus will not flow in the apparatus.

In the present invention, electrode spacing is typically no greater than 5 cm and is usually between 0.1 to 50 millimeters depending somewhat on the thickness of the coated substrate.

In the present invention, glow discharging may be performed to plasma-excite the inert gas and halogen. The frequency of an AC power source used then is not limited particularly, but is preferably 200 to 100,000 Hz, more preferably 500 to 100,000 Hz, and most preferably 1,000 to 10,000 Hz.

Conditions such as voltage, intensity of current, and power upon glow discharging may be selected properly depending on the paint film to be treated. Generally, voltage is preferably 50 to 4,000 V.

Time for which the paint film is plasma-treated may also be selected properly depending on the nature of the paint film. Generally, treating time used is 0.1 to 600 seconds, and preferably 5 to 120 seconds.

Examples of inert gases that may be used are helium, argon, neon, krypton and nitrogen with neon being preferred.

The halogen can be any halogen such as chlorine or fluorine with fluorine being preferred. The source of halogen should be a gas at atmospheric pressure or a material that can be heated to a gaseous state. Examples of suitable sources of halogen include gaseous fluorine and chlorine, tetrafluoromethane, trifluoromethane, difluoromethane, hexafluoropropene, hexafluoropropene oxide and monochloromethane. The concentration of the halogen in the gaseous composition is typically from 2 to 5 percent by volume based on total gaseous volume.

The coating or paint film to be treated in accordance with the invention contains a polymer and optionally pigments and other ingredients found in industrial coatings. The polymer preferably contains ester groups and/or epoxy groups. The ester groups can be pendant ester groups, for example, as found in acrylic copolymers, or the ester group can be in the polymer backbone such as with polyesters and poly(ester-urethanes).

Examples of polyesters are polyester polyols prepared by the polyesterification of an organic polycarboxylic acid or anhydride thereof with organic polyols and/or an epoxide. Usually, the polycarboxylic acids and polyols are aliphatic or aromatic dibasic acids and diols.

The diols which are usually employed in making the polyester include alkylene glycols, such as ethylene glycol, neopentyl glycol and other glycols such as hydrogenated Bisphenol A, cyclohexanediol, cyclohexanedimethanol, caprolactonediol, for example, the reaction product of epsilon-caprolactone and ethylene glycol, hydroxy-alkylated bisphenols, polyether glycols, for example, poly(oxytetramethylene)glycol and the like. Polyols of higher functionality can also be used. Examples include trimethylolpropane, trimethylolethane, pentaerythritol and the like, as well as higher molecular weight polyols such as those produced by oxyalkylating lower molecular weight polyols.

The acid component of the polyester consists primarily of monomeric carboxylic acids or anhydrides having 2 to 18 carbon atoms per molecule. Among the acids that are useful are phthalic acid, isophthalic acid, terephthalic acid, tetrahydrophthalic acid, hexahydrophthalic acid, adipic acid, azelaic acid, sebacic acid, maleic acid, glutaric acid, chlorendic acid, tetrachlorophthalic acid, decanoic acid, dodecanoic acid, and other dicarboxylic acids of varying types. The polyester may include minor amounts of monobasic acids such as benzoic acid, stearic acid, acetic acid, hydroxystearic acid and oleic acid. Also, there may be employed higher polycarboxylic acids such as trimellitic acid and tricarballylic acid. Where acids are referred to above, it is understood that anhydrides of those acids that form anhydrides can be used in place of the acid. Also, lower alkyl esters of the acids such as dimethyl glutarate and dimethyl terephthalate can be used.

Besides polyester polyols formed from polybasic acids and polyols, polylactone-type polyesters can also be employed. These products are formed from the reaction of a lactone such as epsilon-caprolactone and a polyol.

Besides the polyester polyols, poly(ester-urethane) polyols can also be used. These polyols can be prepared by reacting any of the above-mentioned polyester polyols with a minor amount of polyisocyanate (OH/NCO equivalent ratio greater than 1:1) so that free hydroxyl groups are present in the product. In addition to the polyester polyols mentioned above, mixtures of the polyester polyols and low molecular weight polyols may be used. Among the low molecular weight polyols are diols and triols such as aliphatic polyols including alkylene polyols containing from 2 to 18 carbon atoms. Examples include ethylene glycol, 1,4-butanediol, 1,6-hexanediol; cycloaliphatic polyols such as 1,2-hexanediol; and cyclohexanedimethanol. Examples of triols include trimethylolpropane and trimethylolethane. Also useful are polyols containing ether linkages such as diethylene glycol and triethylene glycol. Also, acid-containing polyols such as dimethylolpropionic acid can also be used.

The organic isocyanate that is used to prepare the poly(ester-urethane)polyols can be an aliphatic or an aromatic isocyanate or a mixture of the two. Aliphatic isocyanates are preferred since it has been found that these provide better color stability in the resultant coating. Also, diisocyanates are preferred although higher polyisocyanates and monoisocyanates can be used in place of or in combination with diisocyanates. Where higher functionality polyisocyanates are used, some reactive material to reduce the functionality of the polyisocyanate may be used, for example, alcohols and amines. Also, some monofunctional isocyanate may be present. Examples of suitable higher polyisocyanates are 1,2,4-benzene triisocyanate and polymethylene polyphenyl isocyanate. Examples of suitable monoisocyanates are butyl isocyanate, cyclohexyl isocyanate, phenyl isocyanate and toluene isocyanate. Examples of suitable aromatic diisocyanates are 4,4′-diphenylmethane diisocyanate, 1,3-phenylene diisocyanate, 1,4-phenylene diisocyanate and toluene diisocyanate. Examples of suitable aliphatic diisocyanates are straight chain aliphatic diisocyanates such as 1,4-tetramethylene diisocyanate and 1,6-hexamethylene diisocyanate. Also, cycloaliphatic diisocyanates can be employed and are actually preferred because of color stability and imparting hardness to the product. Examples include 1,4-cyclohexyl diisocyanate, isophorone diisocyanate, alpha, alpha-xylylene diisocyanate and 4,4′-methylene-bis-(cyclohexyl isocyanate).

Besides the polymeric polyol, the coating composition typically comprises a curing agent adapted to cure the polymeric polyol, for example, aminoplast or isocyanate curing agents including blocked isocyanates.

Aminoplast condensates are obtained from the reaction of formaldehyde with an amine or an amide. The most common amines or amides are melamine, urea or benzoguanamine, and are preferred. However, condensates with other amines and amides can be employed, for example, aldehyde condensates or diazines, triazoles, guanidines, guanamines and alkyl and aryl di-substituted derivatives of such compounds including alkyl and aryl-substituted ureas and alkyl and aryl-substituted melamines and benzoguanamines. Some examples of such compounds are N,N-dimethylurea, N-phenylurea, dicyandiamide, formoguanamine, acetoguanamine, 6-methyl-2,4-diamino-1,3,5-triazine, 3,5-diaminotriazole, triaminopyrimidine, 2,6-triethyltriamine-1,3,5-triazine and the like.

While the aldehyde employed is most often formaldehyde, other aldehydes such as acetaldehyde, crotonaldehyde, benzaldehyde and furfuryl may be used.

The aminoplast contains methylol or similar alkylol groups and preferably at least a portion of these alkylol groups are etherified by reaction with an alcohol to provide organic solvent-soluble resins. Any monohydric alcohol can be employed for this purpose including such alcohols as methanol, ethanol, butanol and hexanol.

Preferably, the aminoplasts that are used are melamine, urea- or benzoguanamine-formaldehyde condensates etherified with an alcohol containing 1 to 4 carbon atoms such as methanol, ethanol, butanol or mixtures thereof.

Polyisocyanates and blocked polyisocyanates may also be used as curing agents. Examples of suitable polyisocyanates include monomeric polyisocyanates such as toluene diisocyanate and 4,4′-methylene-bis-(cyclohexyl isocyanate), isophorone diisocyanate and NCO-prepolymers such as the reaction products of monomeric polyisocyanate such as those mentioned above with polyester of polyether polyols. Particularly useful isocyanates are the isocyanurate from isophorone isocyanate commercially available from Chemische Werke Huls AG as T1890 and the biuret from 1,6-hexamethylene diisocyanate commercially available from Bayer as DESMODUR N. The polyisocyanate may optionally be blocked. Examples of suitable blocking agents are those materials that would unblock at elevated temperatures such as low aliphatic alcohols such as methanol, oximes such as methyl ethyl ketone oxime, and lactams such as caprolactam. Blocked isocyanates can be used to form stable one-package systems. Polyfunctional isocyanates with free isocyanate groups can be used to form two-package room temperature curable systems. In these systems, the polymeric polyol and isocyanate curing agents are mixed just prior to their application.

Examples of polymers containing epoxy groups are glycidyl methacrylate containing polymers. Typically these polymers are used in combination with polyacid curing agents. Such curable systems are often in the form of powder coating compositions as described in U.S. Pat. No. 5,407,707.

The coating composition can contain other optional materials such as plasticizers, antioxidants, hindered amine light stabilizers, UV light absorbers, surfactants, flow control agents, thixotropic agents, pigments, fillers, diluents and catalyst. The coating usually has a thickness of 0.001 micron to 1000 microns.

The substrate to which the coating composition is applied is typically a metallic or elastomeric substrate. Examples of suitable metallic substrates can include ferrous metals and non-ferrous metals. Suitable ferrous metals include iron, steel, and alloys thereof. Non-limiting examples of useful steel materials include cold-rolled steel, galvanized (zinc coated) steel, electrogalvanized steel, stainless steel, pickled steel, GALVANNEAL®, GALVALUME®, and GALVAN® zinc-aluminum alloys coated upon steel, and combinations thereof. Useful non-ferrous metals include aluminum, zinc, titanium, magnesium and alloys thereof. Combinations or composites of ferrous and non-ferrous metals, or combinations or composites of metals and non-metals also can be used.

Suitable elastomeric substrates can include any of the thermoplastic or thermoset synthetic materials well known in the art, including fiber reinforced thermoset and thermoplastic materials. As used herein, by “thermosetting material” or “thermosetting composition” is meant one that “sets” irreversibly upon curing or crosslinking, wherein the polymer chains of the polymeric components are joined together by covalent bonds. This property is usually associated with a crosslinking reaction of the composition constituents often induced, for example, by heat or radiation. Hawley, Gessner G., The Condensed Chemical Dictionary, Ninth Edition, page 856; Surface Coatings, vol. 2, Oil and Colour Chemists' Association, Australia, TAFE Educational Books (1974). Once cured or crosslinked, a thermosetting material or composition will not melt upon the application of heat and is insoluble in solvents. By contrast, a “thermoplastic material” or “thermoplastic composition” comprises polymeric components that are not joined by covalent bonds and thereby can undergo liquid flow upon heating and are soluble in solvents. Saunders, K. J., Organic Polymer Chemistry, pp. 41-42, Chapman and Hall, London (1973).

Nonlimiting examples of suitable elastomeric substrate materials include polyethylene, polypropylene, thermoplastic polyolefin (“TPO”), reaction injected molded polyurethane (“RIM”) and thermoplastic polyurethane (“TPU”).

Nonlimiting examples of thermoset materials useful as substrates in connection with the present invention include polyesters, epoxides, phenolics, acrylics, polyurethanes such as “RIM” thermoset materials, and mixtures of any of the foregoing. Nonlimiting examples of suitable thermoplastic materials include thermoplastic polyolefins such as polyethylene, polypropylene, polyamides such as nylon, thermoplastic polyurethanes, thermoplastic polyesters, acrylic polymers, vinyl polymers, polycarbonates, acrylonitrile-butadiene-styrene (“ABS”) copolymers, ethylene propylene diene terpolymer (“EPDM”) rubber, copolymers, and mixtures of any of the foregoing.

The following Examples are presented to demonstrate the general principles of the invention. However, the invention should not be considered as limited to the specific Examples presented.

### EXAMPLE 1

### Coil Coating Application

Pretreated aluminum panels were coated with 3HW73193I Truform® ZT high gloss white polyester coating (a coil coating composition available from PPG Industries, Inc.) by using a wire wound drawdown bar at 0.7-0.8 mil dry film thickness. The coated aluminum panel was baked at 450° F. (peak metal temperature) for 30 seconds.

### Plasma Conditions:

Unit: Lab Atmospheric Plasma Unit with Air-DBO-5000 Plasma Power Supply

Atmospheric Plasma Solutions Inc, 11301 Penny Rd., Suite D, Cary, N.C. 27511

| | Gas | Gap² | | | Pres- | | |
|---|---|---|---|---|---|---|---|
| Exper- | Flow | (inches) | Time | | sure | Fre- | Temp |
| iments | (sccm)¹ | (mm) | (sec) | Volts | (Torr) | quency | ° C. |
| Control - | None | XXX | XXX | XXX | XXX | XXX | XXX |
| No | | | | | | | |
| Plasma | | | | | | | |
| Panel 1 - | 5 liters | 0.25 | 60 | 80 | 730.5 | 33.7 | 28.8 |
| Plasma | He/100 | 6.35 | | | | | |
| | sccm CF4 | | | | | | |
| Panel 2 - | 5 liters | 0.25 | 180 | 80 | 730.5 | 33.7 | 31.2 |
| Plasma | He/100 | 6.35 | | | | | |
| | sccm CF4 | | | | | | |

¹Standard cubic centimeters per minute.
²Gap between electrodes.

### Test Results:

| | H₂O Contact |
|---|---|
| Experiments | Angle³ |
| Control - No Plasma | 85.0 |
| Panel 1 - Plasma | 100.1 |
| Panel 2 - Plasma | 102.2 |

³H₂O contact angle determined with a Kruss DSA100 Contact Angle Meter.

### EXAMPLE 2

### Automotive Refinish Example

Pretreated cold roll steel panels were primed with E-Coat ED6060 available from PPG Industries. A black base coat available from PPG Industries as DMD 1683 Deltron 2000® was reduced with Refinish D871 Medium Thinner®, also available from PPG Industries, at a 1 to 1 volume ratio. After thinning, the basecoat was spray applied to the panels. Two wet coats were applied at about 3.5 mils (8.9×10⁻³ cm) total thickness with a 5-minute flash between coats. Application was done at room temperature in a ventilated spray booth. The basecoat was then air dried for 1 hour. Dry film thickness was about 1.0 mil (2.5×10⁻³ cm).

Next, an acrylic polyol/polyisocyanate hardener available from PPG Industries as DCU2042 Concept® Speed Clear and DCX61 High Solids Hardener was thinned with PPG Industries' DT870 Global Refinish Systems® Fast Thinner at a 4:1:1 mix ratio. Two wet coats were spray applied to the base coat at about 2.5 mils (6.4×10⁻³ cm) total thickness. Application was at room temperature in a ventilated spray booth. Dry film thickness ranged from about 1.25 mils (3.2×10⁻³ cm). The clear coat was air dried for 48 hours. Dry film thickness was about 1.3 mils (3.3×10⁻³ cm). The coated substrates were given a plasma treatment as described below.

### EXAMPLE 3

### Powder Coating Example

Aluminum panels were spray coated with epoxy powder clear PCC10103H that is commercially available from PPG Industries, Inc. The coating was cured at a temperature of 330° F. for 20 minutes. The dry film thickness was about 3.25 mils (8.3×10⁻³ cm). These coated substrates were given a plasma treatment as described below.

### Plasma Treatment

The plasma treatment unit was as described in Example 1. The plasma condition and the water contact angle (determined as described in Example 1) are as follows:

| | | Gap | | | | | | |
|---|---|---|---|---|---|---|---|---|
| | Gas Flow | (inches) | Time | | Pressure | | Temp | Contact |
| Experiments | (sccm) | (mm) | (sec) | Volts | (Torr) | Frequency | ° C. | Angle |
| Refinish | — | — | — | — | — | — | — | 92.8 |
| coating | | | | | | | | |
| (no plasma) | | | | | | | | |
| Powder | — | — | — | — | — | — | — | 77.2 |
| coating | | | | | | | | |
| (no plasma) | | | | | | | | |
| Refinish | 5 liters Neon | 0.25 | 90 | 70 | 733 | 33.7 | 29.2 | 103.2 |
| coating | 100 sccm | 6.35 | | | | | | |
| | hexa- | | | | | | | |
| | fluoropropene | | | | | | | |
| Powder | 5 liters Neon | 0.25 | 90 | 113 | 733 | 33.7 | 33.8 | 102.1 |
| coating | 100 sccm | 6.35 | | | | | | |
| | hexa- | | | | | | | |
| | fluoropropene | | | | | | | |
| | oxide | | | | | | | |

The increase in the water contact angle in Examples 1-3 indicates a more hydrophobic surface caused by the fluorine treatment.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method of treating a coating layer adhered to a substrate comprising:
(a) generating a halogen-containing plasma at atmospheric pressure,
(b) placing the coated substrate in the plasma.

2. The method of claim 1 in which the plasma is generated as a glow discharge plasma within an electromagnetic field.

3. The method of claim 2 in which the glow discharge plasma is generated within a radio frequency electromagnetic field.

4. The method of claim 1 in which the plasma is derived from a gas selected from helium, argon, neon and krypton in combination with a halogen source.

5. The method of claim 1 in which the plasma is derived from a gas selected from neon and a halogen source.

6. The method of claim 1 in which the halogen is fluorine.

7. The method of claim 1 in which the halogen is derived from tetrafluoromethane, trifluoromethane, hexafluoropropene and hexafluoropropene oxide.

8. The method of claim 1 in which the coating layer is based on a polymer.

9. The method of claim 8 in which the polymer contains groups selected from ester and epoxy.

10. The method of claim 9 in which the ester groups are within the polymer backbone.

11. The method of claim 9 in which the polyester is formed from reacting a polybasic acid or anhydride with a polyol.

12. The method of claim 1 in which the polymer is a poly(ester-urethane) and acrylic-urethane.

13. A surface treatment process comprising the steps of:
a) introducing a gas into a plasma reaction apparatus having a pair of electrodes having opposing surfaces,
b) generating a plasma from the gas at atmospheric pressure,
c) surface treating an article placed between the opposing electrodes, wherein the article is a coated substrate and the plasma contains a halogen.
